(19) United States
(12) Patent Application Publication
(10) Pub. No.: US 2005/0203998 A1
(43) Pub. Date: Sep. 15, 2005

(54) Method in a digital network system for controlling the transmission of terminal equipment

(76) Inventors: Kimmo Kinnunen, Aanekoski (FI); Mika Rantaniva, Aanekoski (FI); Matti Lehtimaki, Espoo (FI)

Correspondence Address: HARRINGTON & SMITH, LLP, 4 RESEARCH DRIVE, SHELTON, CT, 06484-6212, US

(21) Appl. No.: 10/515,286

(22) PCT Filed: May 26, 2003
(86) PCT No.: PCT/FI03/00400

§ 371 Date: Nov. 19, 2004

(30) Foreign Application Priority Data
May 29, 2002 (FI) 20025028

(51) Int. Cl. G06F 15/16

(52) U.S. Cl. 709/204; 709/230; 370/338; 709/228; 455/518

(57) ABSTRACT

The invention concerns a method in a digital network system for controlling the transmission of terminal equipments. Terminal equipment includes a PTT (Push-to-Talk) function in order to at least activate the transmission to be carried out to the said network system, and wherein the terminal equipment for voice control of the said PTT function also includes a VOX (Voice Operated transmission) feature, which can be activated/passivated and which is implemented by a VRE (Voice Recognition Engine) function. In the method stops are performed—the VRE function is used to search for an established keyword from an audio signal,—the established keyword is recognised from the audio signal,—a turn to transmit is requested from the network system,—a turn to transmit is received from the network system,—the transmission is connected and the granted turn to transmit is indicated,—the transmission is carried out, and—the transmission is passivated. In the said VOX feature before the said VRE function the audio signal is monitored by a VAD. (Voice Activity Detection) function arranged in connection with terminal equipments, and whereby when activating the said VOX feature in the terminal equipment steps are performed before the said partial steps the terminal equipment's incoming audio signal is processed with the VAD function searching it for a signal form in accordance with an established criterion, and—when a signal form according to the established criterion is detected in the audio signal, the said VRE function is activated to search for an established keyword.

The invention concerns a method in a digital network system for controlling the transmission of terminal equipment, which terminal equipment includes a PTT (Push-to-Talk) function at least to activate the transmission to be carried out to the said network system, and wherein the terminal equipment also for voice control of the said PTT function includes a VOX (Voice Operated transmission) function, which is activated/passivated and which is implemented by a VRE (Voice Recognition Engine) function, and in which method the following takes place by steps
the VRE function is used to search for an established keyword from an audio signal,
the established keyword is recognised from the audio signal,
a turn to transmit is requested from the network system,
a turn to transmit is received from the network system,
the transmission is connected and the granted turn to transmit is indicated,
the transmission is carried out, and
the transmission is passivated.

The invention may also be applied in PoC (Push-to-talk over Cellular) speech services systems.

In digital radio network systems, such as, for example, the TETRA (TErrestrial Trunked RAdio) system, semiduplex communication represents an efficient mode of communication from the viewpoint of system capacity. Usual bottlenecks in system capacity are the limited bandwidth and the system's processing ability. In order to carry out semiduplex communication only one downlink traffic channel is needed for the broadcasting from the base transceiver station to the terminal equipment and one uplink traffic channel is needed for the transmitting terminal equipment. Communication on the channels is by so-called broadcasts, which the TETRA switching centre transmits to all pieces of terminal equipment, even if a message is intended for one of them only. In order to arrange uplink traffic a definite method of trunking is usually required, which is used to organize the transmissions of the terminal equipment.

However, it is a requirement in semiduplex communication that there is only one transmitting party at a time in the system. This requirement is typically met with the PTT (Push-to-Talk) switch of the terminal equipment, which the user must push when wishing to transmit. Pushing of the PTT switch produces a request for a turn to transmit, based on which the trunking system of the TETRA switching centre grants one party at a time a turn to talk based on his talking turn indication algorithm.

All the parties engaged in semiduplex communication, both in group and also in direct private calls (personal semiduplex), must also in the TETRA system, which is e.g. used by the authorities, request and obtain their turns to transmit before their turn to talk. Traditionally, this has been implemented by using the PTT switch of the terminal equipment. However, this method restricts essentially the activity of the user of the terminal equipment during the communication, because he must use one hand to press the PTT switch.

There are several practical situations both in office and field conditions, where it would be practical to have both hands free. Examples of such situations are communications carried on in vehicles, such as when driving a motorbike or a car, and further, for example, in the case of an electrician commenting on his electric installation, when the electrician needs both his hands in order to figure out the installation or for other such measures.

Furthermore, situations of a similar kind where both hands must be free also occur in connection with terminal equipment supporting the PoC (Push-to-talk over Cellular) feature/service. It is a characteristic of the PoC feature that it is implemented as a duplex radio service of a kind known as such. The user of the terminal equipment can there be in a constant connection, practically speaking, with his own group, but despite this, maintenance of the connection does not keep the transmission channel busy all the time.

When using the PoC feature, the user pushes the transmission key in the earpiece of his terminal equipment, whereupon he can immediately say the message to be transmitted. All such parties belonging to the same group as the user, who at the time of transmission are connected to the data communication network, for example, over a packet connection (such as GPRS), will hear the message. The PoC feature also supports at least two transmission modes. In the first mode, one of the parties may address a group call to the other parties, while in the second mode one of the parties may address a direct call to some other party.

In addition to the above-mentioned traffic situations, situations requiring free use of both hands when using the PoC feature may occur, for example, when playing network games. Hereby the players give comments to the other parties as the game proceeds. According to the state of the art, a manual connection must be made in order to carry out the transmission. Another problem is that the user cannot easily carry on private communication with another certain party when a group call is going on.

The VOX function, that is, Voice Operated transmission, is a feature known from some analog PMR (Private Mobile Radio) pieces of terminal equipment used in semiduplex communication. In these, the VOX feature allows requesting a turn to talk without pushing the PTT switch manually.

The use of VAD (Voice Activity Detection) is known from the implementation of DTX (Discontinuous Transmission). Hereby, when a voice is not detected with VAD in the microphone signal during the call, the terminal equipment is not either used for transmitting whole uplink bursts corresponding with these quiet moments. The function is used to save duration of the transmission power and thus to prolong the effective operating time of the terminal equipment.

Some types of mobile station terminal equipment are nowadays equipped with a talk detection feature. In these, the user can control the terminal equipment by uttering a command he has defined, such as, for example, the name of the party to be called, “Charlie”. In consequence of the command, the terminal equipment activates the subscriber identity of the party to be called (Charlie's). According to the user's choice, the subscriber identity activated by the command can be acknowledged by pushing a key, or the terminal equipment may also without any action on the part of the user call the subscriber identity of the party activated by the command.

Due to the constant consumption of current of the active audio parts, such as, for example, the processor processing audio data, it is very disadvantageous especially in mobile terminal equipment to implement such a VOX function based on a program-based solution, which constantly meets the incoming audio signal and detects talk or individual words in this.

Many methods of implementing VOX have been proposed, but these have usually been based on hardware-level solutions, such as, for example, integrated additional VOX circuits or separate circuit diagrams. Drawbacks of solutions of this kind are increased component costs, the additional space needed by components and obviously also the increased consumption of current of the terminal equipment's bigger standby space. Software-based implementations are also known, such as, for example, the above-mentioned constant audio monitoring. The increased current consumption also restricts the use of these in mobile terminal equipment. These solutions may, however, be functioning e.g. in car installation series, where current consumption is not a major problem as such.

As regards the state of the art, reference is made to PCT publication WO-96/11529 and to U.S. Pat. No. 5,912,882. Publication WO 96/11529 presents activation of the transmission of a radio telephone by using the voice recognition function. Here the terminal equipment performs continuous recognition of keywords on the audio data. However, power is consumed considerably in the use of the voice recognition (VRE) function based on recognition of words for activating connection of the transmission, which is a real problem, especially with pieces of mobile terminal equipment.

Publication U.S. Pat. No. 5,912,882 presents implementation of a private communication system in a PSTN network. This includes a mention of activation of the PTT facility by voice control. However, this is not a genuine digital network system, but the signal undergoes DA conversion when moving from a wireless network (CDMA) to a telephone network (PSTN). However, activation of the PTT function by voice recognition will not function at all in practical situations, because in principle the transmission is activated by every audio signal recognisable as a voice or generally, for example, as talk. In addition, passivation of the PTT is performed by detecting a pause, the duration of which is established in advance.

All things considered, it is difficult to bring about a functioning and especially a reliable and efficient VOX function with state-of-the-art solutions, particularly in mobile terminal equipment, for example, especially in a digital trunking system, where the terminal equipment must make a request to the trunking system for a turn to talk.

It is the purpose of this invention to bring about an essentially more advantageous, more user-friendly and more reliable method for controlling transmission of the terminal equipment in a digital network system. The characteristic features of the method according to the invention are presented in claim 1.

The method according to the invention makes possible implementation of the VOX feature in its simplest form in every piece of terminal equipment with existing VAD (Voice Activity Detection) and VRE (Voice Recognition Engine) algorithms, which are preferably used in accordance with the method of the invention in detection of the audio signal and in searching this for one or more keywords. The VRE function can be implemented simply with audio DSP (Digital Signal Processing) algorithms and it may be used for detecting in the audio signal a request for a turn to talk and also generally key words activating the transmission, depending on the network system being used.

Activation of the feature may be done with a special UI (User Interface) concept, thus allowing its flexible on/off switching. In practice, this means that the user of the terminal equipment must first activate the VOX feature in some way, whereupon the feature is active, for example, for an established period of time, a logical sequence or according to choices made by the user in the UI.

The method according to the invention improves essentially the usability of the terminal equipment in semiduplex traffic. An advantage is attained in trunking systems, such as the TETRA. With the feature in question advantages are also attained in PoC (Push-to-talk over Cellular) group communication, which is one embodiment of the VoIP (Voice over Internet Protocol) professional talk services designed for All-IP-based systems. One of their objectives is to control the talk for transfer as IP packets, for example, through the GPRS system.

When implemented entirely on a software basis without any additional equipment or components installed in the terminal equipment, the VOX feature as a combination of VAD and VRE functions significantly reduces variable costs, reduces the size of the printed circuit board of the terminal equipment and reduces the basic current consumption in particular. When implemented in accordance with the method, the feature can be implemented advantageously on existing known product platforms, because their audio parts usually include the required VAD and VRE functions. The software-based solution and the user interface concept give many possibilities of configuring the settings relating to the function, such as, for example, its ON/OFF feature and activation and passivation settings according to the needs of the users.

According to one embodiment, the method according to the invention may also be used, for example, in the above-mentioned PoC group communication. Hereby the concept may be different from trunking systems, for example, as regards the types of talk and allocation of turns to talk. In PoC group communication, the method according to the invention may be utilised as an additional form of application, besides the said activation of transmission, for a combined choice of recipient.

Other additional advantages achieved with the method according to the invention emerge from the specification part, while the characteristic features emerge from the appended claims.

The method according to the invention, which is not limited to the embodiments to be presented hereinafter, will be described in greater detail by referring to the appended figures, wherein

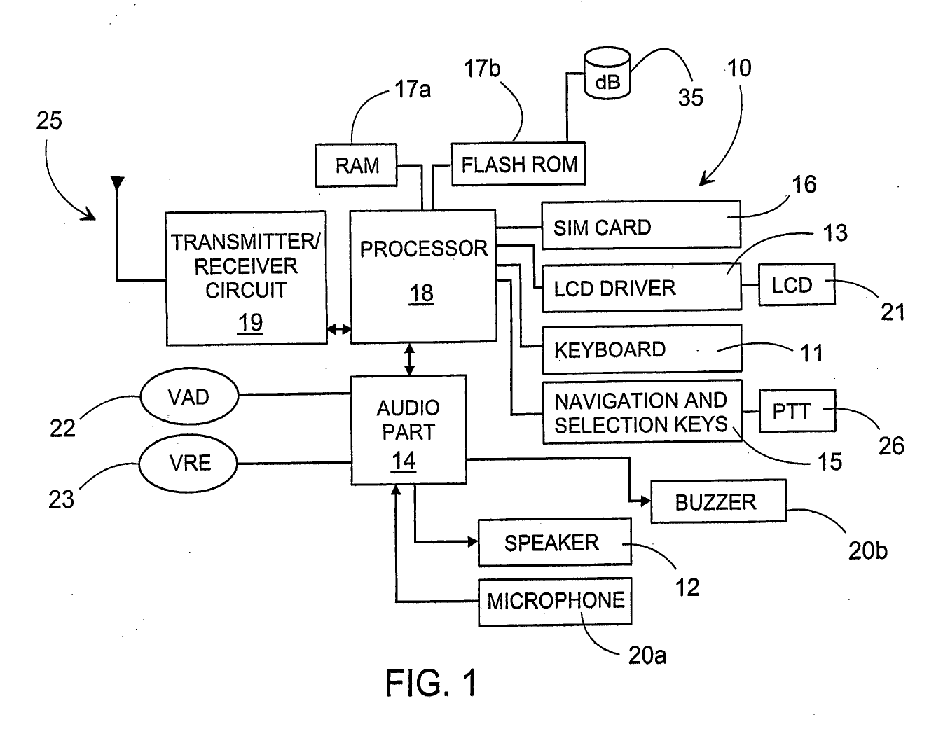

FIG. 1 shows an example of the functional parts of a terminal equipment,

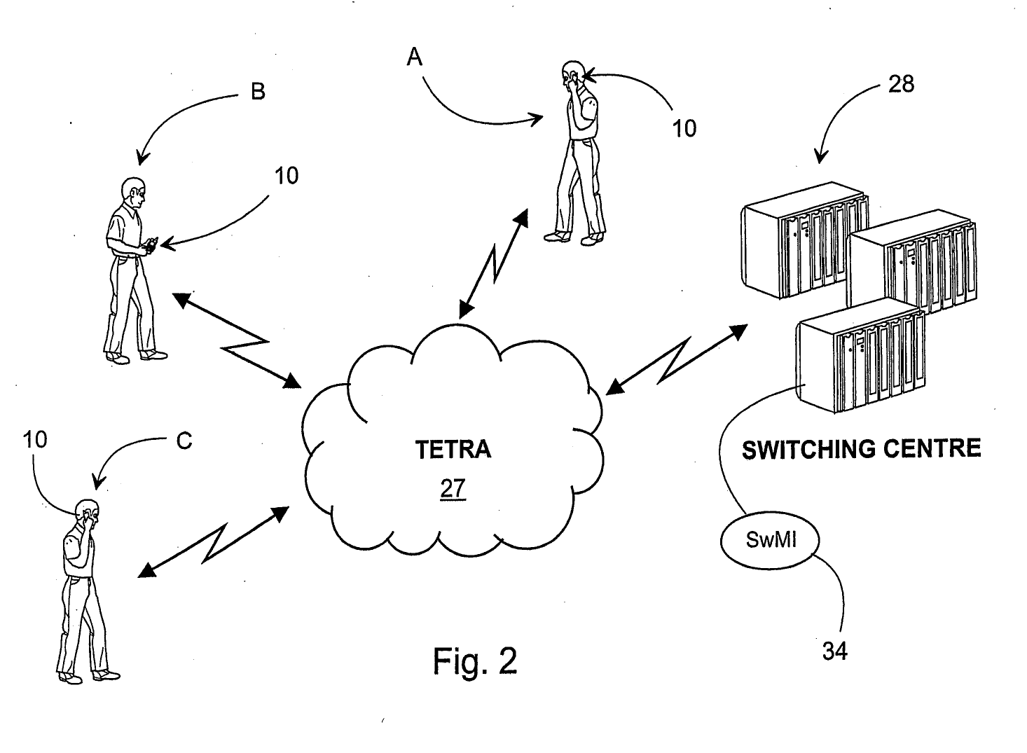

FIG. 2 shows an example of an application of the method according to the invention,

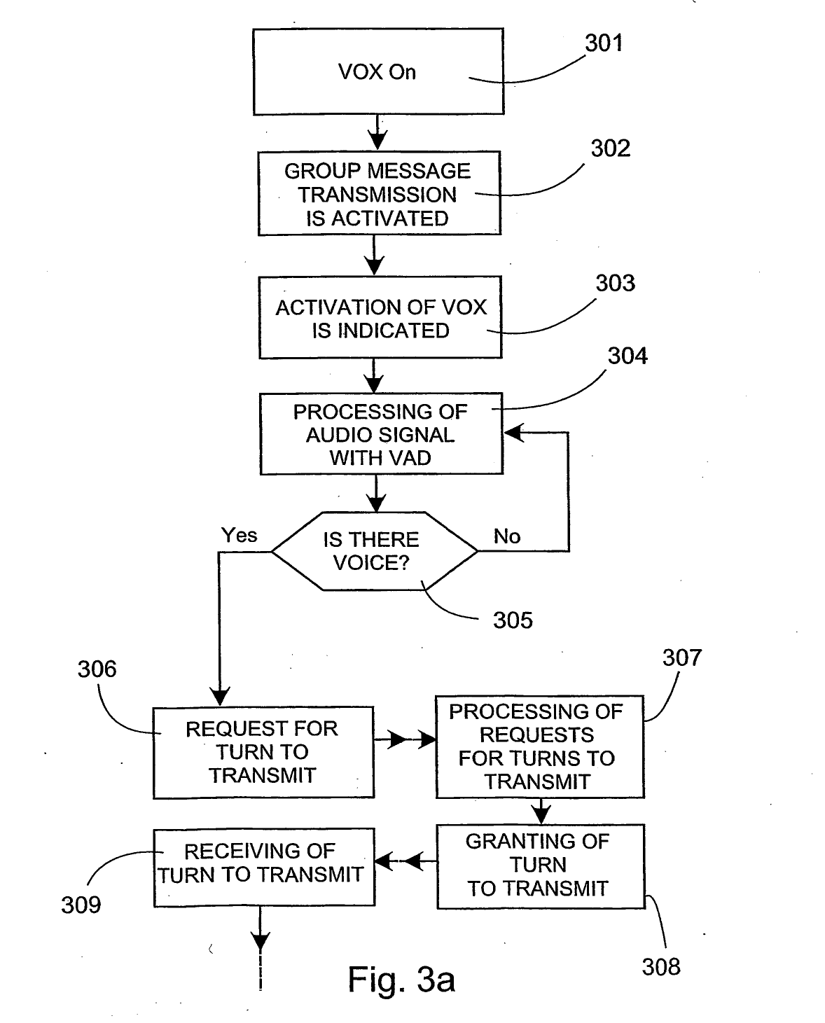

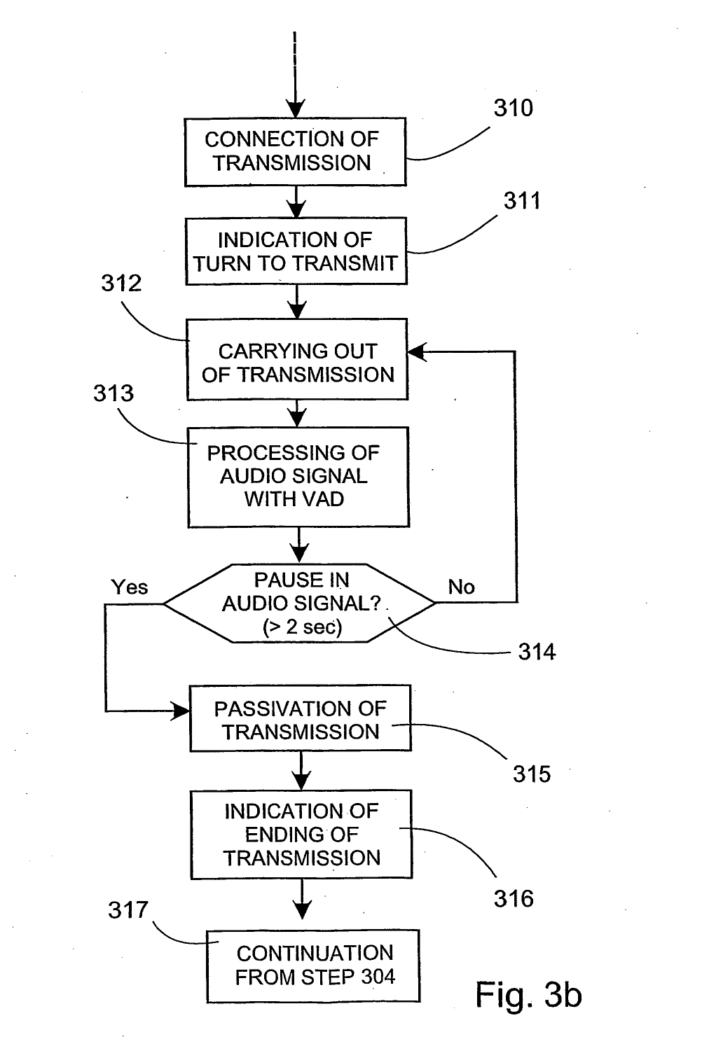

FIGS. 3a and b are flow diagrams showing an example of an embodiment of the method according to the invention,

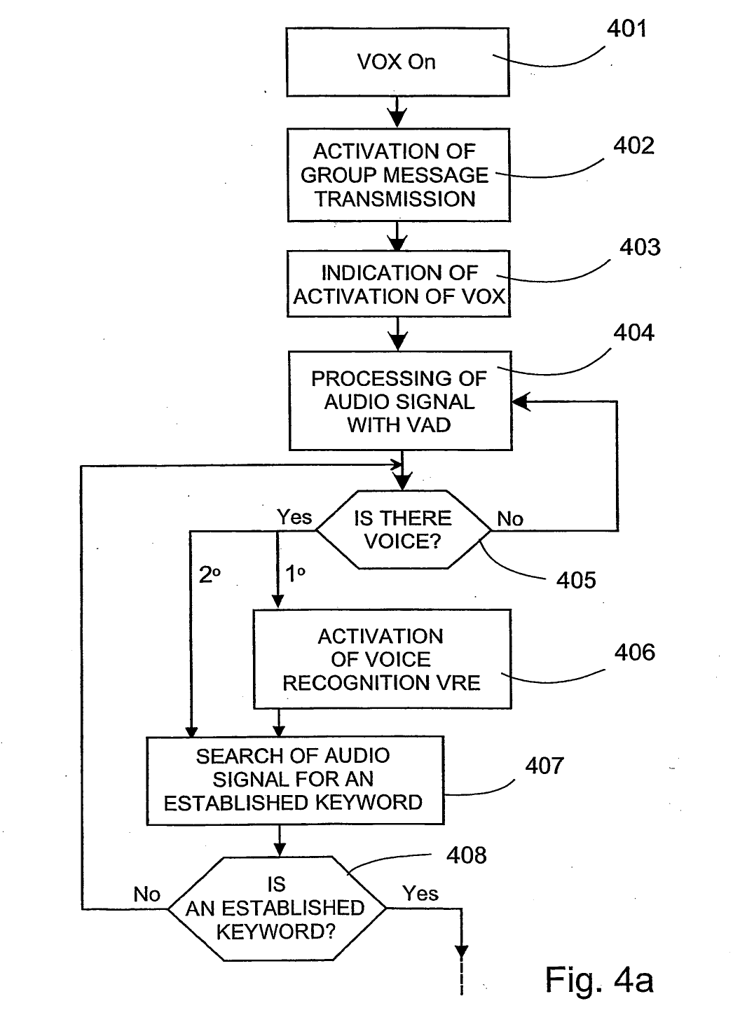

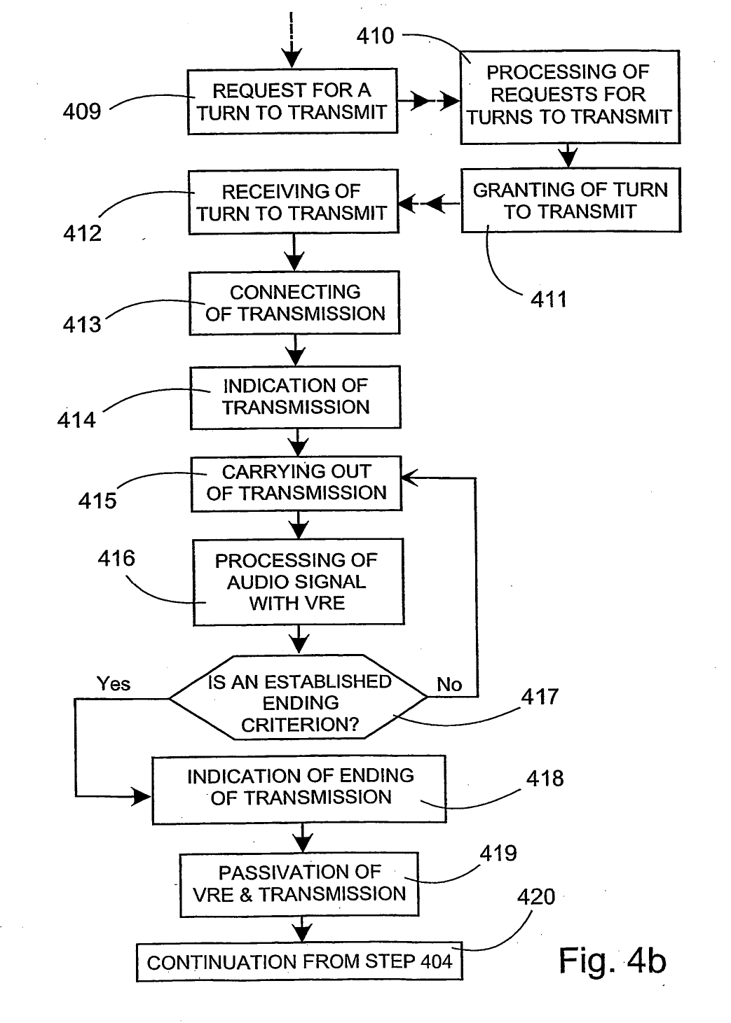

FIGS. 4a and b are flow diagrams showing an example of another embodiment of the method according to the invention, and

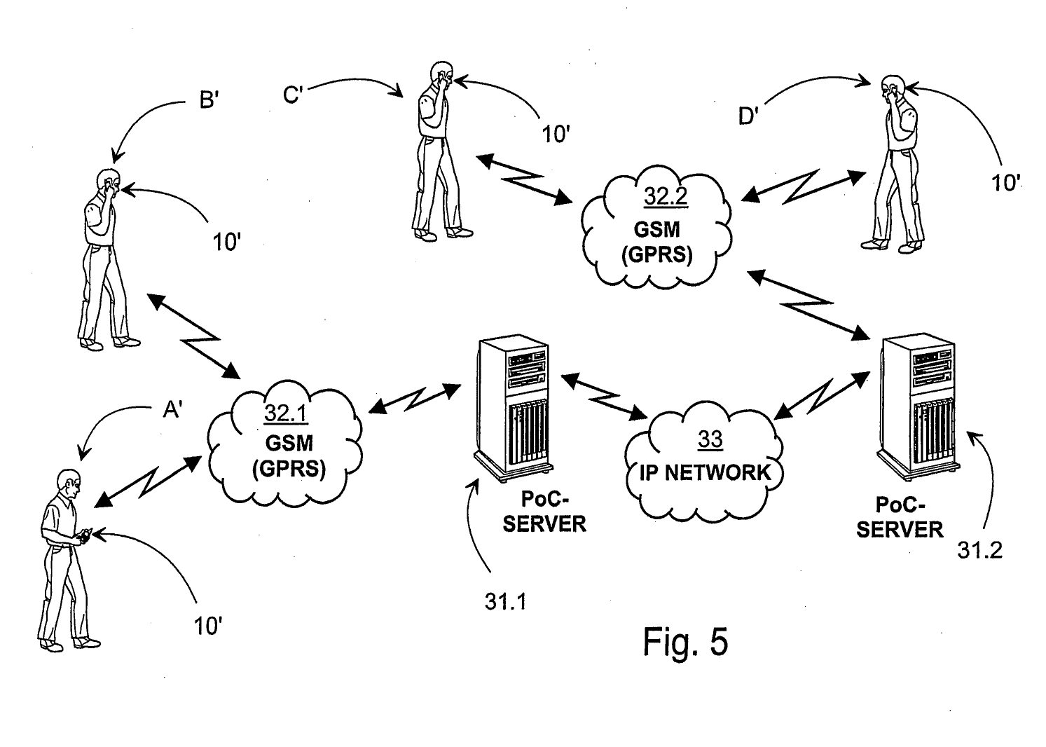

FIG. 5 shows another example of an application of the method according to the invention.

FIG. 1 shows an example of the functional parts of a digital terminal equipment 10 implementing the method according to the invention. In connection with the processor unit 18 of the terminal equipment 10 a transmitter-receiver circuit 19 is arranged, in connection with which an antenna 25 is connected, among other things, to carry out and receive transmission. Furthermore, in connection with processor unit 18 there are keyboard 11 of the terminal equipment 10, navigation and selecting keys 15 and switches as well as a possible SIM (Subscriber Identity Module) card 16. Among other things, a PTT (Push-to-Talk) switch 26 controlling a possibly occurring request for a turn to transmit and controlling the transmission also belongs to the said switches.

The terminal equipment 10 may include an LCD display 21, which is arranged in connection with a display controller 13, which is also arranged in connection with processor unit 18. Furthermore, in connection with processor unit 18 are arranged RAM memory 17a and up-datable ROM memory 17b as well as audio part 14, in connection with which are arranged loudspeaker and microphone means 12, 20a of a kind known as such as well as a possible buzzer 20b. It should be noticed that the functional parts of the terminal equipment 10 shown in FIG. 1 are shown in quite a rough manner by way of example. Terminal equipment may be implemented in many different ways, for example, depending on its type, but these are obvious to the man skilled in the art.

It is essential for the method according to the invention that, for example, in the audio part 14 of terminal equipment 10 an algorithm module 22, that is, voice detection, is arranged as a software sub-section implementing the VAD (Voice Activity Detection) function. According to a more advanced embodiment, the functionality of the audio part 14 includes as a sub-section, besides the VAD module 22, also a DSP module, which includes a VRE (Voice Recognition Engine) function 23, that is, voice recognition.

In the following some advantageous embodiment of the invention will be described with reference made to FIGS. 2, 3a and 3b. FIG. 2 is a schematic view of an application of the method according to the invention. Users A, B and C, who may be, for example, police officers on patrol in the field or representatives of some other such authority, business enterprise or public transport department, have pieces of terminal equipment 10 according to the functionality shown in FIG. 1. According to one embodiment, the pieces of terminal equipment 10 are intended to operate in a network system based on a digital trunking system, such as in the TETRA (TErrestrial Trunking RAdio) 27. It is typical of the Trunking system that when a terminal equipment 10 asks the trunking system for a turn to transmit, the system's SwMI (Switching and Management Infrastructure) will distribute turns to transmit according to established criteria. Such criteria may be, for example, the requesting order, the priority level of the users A, B, C and the active type of transmission of their terminal equipment 10 (for example, an emergency call vs. an ordinary turn to talk).

FIGS. 3a and 3b are flow diagrams showing an advantageous embodiment of the method according to the invention in a trunking system. Users A, B, C activate the VOX feature, for example, manually, from the user interfaces UI of their TETRA terminal equipment 10 with the ON/OFF setting (301). After this measure, the terminal equipment 10 activates a group message transmission by a brief push on the PTT switch (duration <500 ms) (302). Upon activation of the VOX feature, a signal tone or other such notification, such as a signal light, is given, for example, with buzzer 20b of the terminal equipment (303).

When the VOX feature implemented according to the method of the invention is active, the audio path is kept open all the time.

The audio signal arriving through microphone 20a is processed without interruption in a manner known as such with the VAD algorithm (304), which is used to search the audio signal for a signal form according to the established criterion, such as, for example, possible talk of the user of the terminal equipment (305). If needed, the sensitivity of the microphone 20a and the VAD module 22 can be adjusted, in order to avoid, for example, any false transmissions connected by strong background sounds. According to the method of the invention, the VAD function 22 is used to look for the initial point of talk in the audio signal arriving by way of the microphone 20a. With the VAD algorithm fitted in connection with the VAD module 22 any rise of the signal level is detected in the audio signal arriving through microphone 20a, which rise may be talk. It is not possible with the VAD function 22 to distinguish talk or individual words from the sound.

In this first embodiment based solely on the VAD function 22, the user's A, B, C first word, with which the user can activate a request for a turn to transmit, must be something else than real talk intended for transmission. Before his utterance to be transmitted, user A, B, C must utter, for example, the word “VOX” or any other word or sound. Hereby VAD 22 detects a possible transmission and transmits a request for a turn to transmit to the network system's switching centre 28 (306). The SwMI arranged in switching centre 28 processes the request for a turn to transmit (307) and if at that time there is no traffic in the group formed by users A, B, C, SwMI will grant a turn to transmit to the requesting terminal equipment 10, usually almost immediately (308). If there is much traffic in the group, then the users have to wait for their turn to transmit, depending e.g. on the priority level of the user A, B, C sending the request. Terminal equipment 10 receives a permission to transmit (309), and the following partial steps (310-317) will be explained in greater detail hereinafter.

In an embodiment based on the VAD function 22, where the user A, B, C utters the command “VOX” activating the VOX feature and then immediately the message he wishes to be transmitted, words may be left out from the beginning of the message. A way to avoid this is to reserve more memory space in order to buffer microphone talk. However, in this case longer talk delays will result, which may be no less than tens of milliseconds. Transmissions activated by strong background sounds are a significant drawback in solutions based on the VAD function only.

Another more advantageous way of implementing the method according to the invention is shown in FIGS. 4a and 4b. This uses the VAD function 22 presented above, and in connection with this a VRE function 23, that is, word recognition. Users A, B, C activate the VOX feature, for example, manually from the user interfaces UI of their pieces of TETRA terminal equipment 10 with the ON/OFF setting (401). After this action terminal equipment 10 activates a group message transmission by a brief push on the PTT switch (duration <500 ms) (402). Upon activation of the VOX feature, a signal sound or other such notification, such as a cue light signal (403), is given using, for example, the buzzer 20b of the terminal equipment 10.

When the VOX feature implemented in accordance with the method of the invention is active, the audio path is kept open all the time. The audio signal arriving through microphone 20a is processed without interruption by a VAD algorithm in a manner known as such (404), which algorithm is used to search for a signal format according to the established criterion, such as, for example, possible talk of the user of the terminal equipment (405). When required, the sensitivity of microphone 20a and VAD module 22 can be adjusted in order to avoid faulty transmissions turned on by, for example, strong background noises. Thus, according to the method of the invention, the VAD function 22 is used to search for the starting point of talk in the audio signal arriving through microphone 20a. The VAD algorithm adapted in connection with VAD module 22 is used to detect a raise of the signal level in the audio signal coming in through microphone 20a, which raise may thus be talk. The VAD function 22 cannot be used for distinguishing talk or individual words in the sound.

When the VAD function 22 detects for the first time in the audio signal (1°) a signal possibly intended into the microphone 20a by user A, B, C, the voice recognition function VRE 23 of the terminal equipment 10 is activated (406).

In voice recognition 23, a search is made in the talk coming in through microphone 20a for e.g. an utterance of “VOX” or for some other essentially predetermined key word (408). In case the established key word is not found within an established period of time, the procedure may return, for example, to step (405) to find out whether there is any such signal on the audio path that might be understood as a voice. If there is, then the procedure moves on directly to step (407) along route (2°).

After the voice recognition 23 has found the correct key word, terminal equipment 10 will send a request for a turn to transmit (409) to the SwMI 34 of the trunking system, corresponding to the pushing of PTT switch 26 to the bottom, as is done nowadays.

SwMI 34 processes the requests for turns to transmit (410) and grants it in a sequence to the requesting terminal equipment 10 (411). When the terminal equipment 10 has received the granted turn to transmit (412) from SwMI 34, the transmission is turned on (413) and it is indicated, for example, with a TX Granted tone (414). User A, B, C dictates the message to be transmitted into microphone 20a and terminal equipment 10 transmits it to the data communication network 28 in a known manner (415).

According to one embodiment of the invention, passivation of the transmission may be detected in such a way that the VAD algorithm 22 is used to process the audio signal during the transmission (313), and if a sufficiently long pause, for example, of a length set in advance (for example, 1-2 seconds) (314) is detected in the talk, the transmission is passivated in a corresponding manner as when releasing the PTT switch 26 (316). Then the procedures goes back to step (304), depending, for example, on the user's actions or on the settings of the VOX feature (317).

One or more special key words identifiable with the VRE function 23 constitute a more advanced embodiment for controlling the transmission. Hereby the audio signal is processed with the VAD or VRE function 23 (416) during the transmission. In the processing a search is made in the audio signal for an established ending criterion, which may be, for example, a key word (417). Another example of such an ending criterion is a pause of an established length in the talk, because it is always possible that voice recognition based on probability calculation can fail in some way. When an established keyword or a pause of an established length is found, passivation of the transmission is indicated (418) and the VRE and transmission are passivated (419). The procedure can then move on to step (404) (420).

By using keywords the users A, B and C can control when talk is being transmitted to the network system 27 and when it is not transmitted. An example of such use of a keyword could be “Vox (pause) assisting forces are needed here, over!”. Hereby the recipients hear the phrase “Assisting forces are needed here, over!” Now, besides the word Vox, the word over is also set in the database dB arranged in connection with voice recognition 23. Database dB may be stored, for example, in the memory means 17a of the terminal equipment 10. When the VRE function 23 finds the word over in the talk signal, the conclusion can be drawn that the intention is to end the transmission.

The audio path may be kept open for the VOX feature during a time determined by the user or until an active group call is ended. Thereupon the VAD and VRE functions are closed in order to minimize the consumption of power.

The users A, B, C may carry out the passivation of the VOX feature, for example, by briefly pushing the PTT switch 26, whereby the feature is immediately passivated. This, too, is indicated to the user A, B, C, for example, with a tone signal or in some other suitable manner.

When needed, the VOX feature can also be temporarily cancelled. According to an advantageous embodiment, the users A, B, C may carry out the cancellation by keeping the PTT switch 26 pushed down for a long time, whereby transmission performed with the PTT switch 26 may be used instead of the VOX feature. After the transmission, the PTT switch 26 is released in a known manner, whereby the VOX feature according to the invention is once again active.

Users A, B, C may store keywords in database dB and program terminal equipment 10 within the limits set by the memory capacity and by the voice recognition 23. When programming keywords, the user A, B, C of terminal equipment 10 teaches the voice recognition and establishes functions corresponding to the commands he has taught. The manner of implementation may be dependent on or independent of the speaker.

At algorithm level, implementation of the method according to the invention can be arranged as regards the VAD function 22 to take place, for example, at time level. Hereby a rise of the audio signal is detected, which rise must be sufficiently distinct. It is also possible to utilise recognition of the talk spectrum at frequency level. Hereby the audio signal must resemble talk, the signal of which is usually in a range of 100 Hz-1.5 kHz. Hereby one significant criterion as regards functionality is to distinguish talk from background noise in the signal.

FIG. 5 shows another application example, wherein the method according to the invention may also be used. Here the network system 32.1, 32.2, which supports, for example, the GPRS transmission mode, is connected in connection with All-IP infrastructure 31.1, 31.2, 33. Hereby the terminal equipment 10′ supports, for example, the PoC group communication feature/service. Activation of the VOX feature of the terminal equipment 10′ is carried out, for example, with a switch reserved for this purpose. It is possible also in PoC group communication to implement the method according to the invention in at least the two ways presented above (VAD, VAD & VRE).

In the first way of implementation, the terminal equipment 10′ equipped with the PoC function is arranged in a special HF (hands free) mode. Hereby, when the VOX feature implemented in accordance with the method of the invention is activated and the user A′, B′, C′ says something, terminal equipment 10′ will always transmit a PoC talk message packet. Buffering of packets and timing/sequencing of transmissions to recipients is controlled with the PoC server 31.1, 31.2. Recognition of the transmission may preferably be implemented with a VAD module of a basic model, which detects starting and ending points of talk in a signal possibly interpreted as talk, and based on these the transmission is controlled instead of pushing and releasing a tangent.

In the second way of implementation, implementation of the VOX feature in connection with the PoC function is based both on the VAD function and on the VRE function in the manner described above. In this case, the terminal equipment 10′ capable of the PoC function carries out a specific HF (hands free) tangent keyword mode. Hereby terminal equipment 10′ always transmits in the PoC function a talk message packet, when a person A′, B′, C′ utters a password and then a sentence. This may also be implemented with the VAD and VRE modules of a basic model presented above, wherein the VAD module detects starting and ending points of a sentence and the VRE module recognizes a keyword and the transmission is controlled not by pushing/releasing a tangent but according to starting and ending points of a sentence detected by the VAD module.

In another advantageous embodiment, the user A′, B′, C′ may store several keywords in the PoC terminal equipment 10′. Hereby it is possible for the user A′, B′, C′ to choose such individual users from his group, to whom he addresses the transmission just by uttering, for example, the keyword stored as the identifier corresponding to the user intended to be the recipient. In this way the user may transmit private messages directly only to this certain user of his choice. The feature of the described kind can of course also be activated by hand as a menu selection, but in certain conditions it is more natural to do this by talking.

Furthermore, according to an embodiment, the user may use a keyword consisting of two parts, which improves the distinguishing ability of the method. For example, when used as a keyword, “chat Jill” is a better combination as a keyword than just “Jill”. The word “group”, for example, may be stored as a keyword referring to the whole group. Different combinations may preferably be used in the method. Such combinations may be, for example, pushing a tangent when a group call is active and then uttering a keyword, such as a name, in order to choose the recipient of the transmission.

When using VAD and VRE modules in the PoC system, a non-standard additional field is added to the IP packet used in the system (RTP (Realtime Transport Protocol) packets are typically used). The additional field is noticed by the PoC server 31.1, which relays the message only to those recipients, who are mentioned in the additional field.

If the VRE module finds the receiving party in its database, a confirmation of an established form is given, which indicates a successful choice of voice. The confirmation may be, for example, a short beep sound or a repetition of the keyword to the user. After the confirmation is heard (or even before that, whereby the confirmation may also be given after the end of the sentence to be transmitted) the user may dictate the message he wishes to transmit.

Especially saving in the power consumption of the terminal equipment is achieved with the method according to the invention. For example, in a noisy environment a terminal equipment using recognition based only on keywords must constantly process the signal on the audio path, which is not necessarily even talk. As in the method according to the invention this essentially constant process of keyword identification is not performed until such sound is detected on the audio path, which is in a frequency range preferably of talk form, significant saving in the basic power consumption is hereby achieved.

It should be understood that the above specification and the figures relating to it are only intended to illustrate the method according to the present invention. The procedural implementation of the method can be in numerous different ways, which are obvious to the man skilled in the art. Thus, the invention is not limited only to the embodiments presented in the foregoing or to those defined in the claims, but many such variations and modifications of the invention will be obvious to the man skilled in the art, which are possible within the scope of the inventive idea defined in the appended claims.

1. Method in a digital trunking network system for controlling the transmission of terminal equipment, which terminal equipment includes a PTT (Push-to-Talk) function in order to at least activate the transmission to be carried out to the said network system, and wherein the terminal equipment for voice control of the said PTT function also includes a VOX (Voice Operated transmission) feature, which can be activated/passivated and which is implemented by a VRE (Voice Recognition Engine) function, and in which method steps are performed
the VRE function is used to search for an established keyword from an audio signal,
the established keyword is recognised from the audio signal,
a turn to transmit is requested from the network system,
a turn to transmit is received from the network system,
the transmission is connected and the granted turn to transmit is indicated,
the transmission is carried out, and
the transmission is passivated,
characterized in that in the said VOX feature before the said VRE function the audio signal is monitored by a VAD (Voice Activity Detection) function arranged in connection with terminal equipments, and whereby when activating the said VOX feature in the terminal equipment steps are performed before the said partial steps
the terminal equipment's incoming audio signal is processed with the VAD function searching it for a signal form in accordance with an established criterion, and
when a signal form according to the established criterion is detected in the audio signal, the said VRE function is activated to search for an established keyword.

2. Method according to claim 1, characterized in that
the audio signal is processed with the VAD function during the transmission,
the audio signal is searched for a pause of an established length,
a pause of the established length is found in the audio signal, whereby the signal established to indicate ending of the transmission is indicated and the transmission is passivated.

3. Method according to claim 1, characterized in that
the audio signal is processed with the VRE function during the transmission,
the audio signal is searched for the established ending criterion,
the established ending criterion is found in the audio signal, whereby the signal established to indicate ending of the transmission is indicated, and the transmission is passivated.

4. Method according to claim 1, characterized in that the VOX feature is turned on for an established period of time or until the active group call ends, whereupon the VAD and VRE functions are passivated.

5. Method according to claim 1, characterized in that the VOX feature can be temporarily cancelled with an established measure.

6. Method according to any one of claims 1, characterized in that for the VRE function a special database (dB) is arranged in memory means of the terminal equipment, in which database the user stores keywords to activate and passivate the transmission.

7. Method in a digital network system for controlling the transmission of terminal equipment, wherein the said network system is arranged in connection with an All-IP infrastructure equipped with a server, and the said terminal equipment is arranged to support the PoC (Push-to-talk over Cellular) feature/service and wherein the terminal equipment includes a PTT (Push-to-Talk) function to at least activate the transmission to be carried out to the said network system, and wherein the terminal equipment for voice control of the said PTT function also includes a VOX (Voice Operated transmission) feature, which can be activated/passivated and which is implemented by a VRE (Voice Recognition Engine) function, and in which method the following steps are performed while carrying out the transmission with the PTT function
the VRE function is used to search for an established keyword from the audio signal,
the established keyword is recognised from the audio signal,
the transmission is activated and
the transmission is passivated,
characterized in that in the said VOX feature before the said VRE function the audio signal is monitored by a VAD (Voice Activity Detection) function arranged in connection with the terminal equipment, and whereby when activating the said VOX feature at the terminal equipment the following steps are performed before the said partial steps
the terminal equipment's incoming audio signal is processed with the VAD function searching it for a signal form in accordance with an established criterion, and
when a signal form in accordance with the established criterion is found in the audio signal, the transmission of the terminal equipment is activated carrying out the said partial steps.

8. Method according to claim 7, characterized in that keywords are used, besides to activate the transmission, to choose the recipient of the transmission.
